(19) United States
(12) Patent Application Publication
(10) Pub. No.: US 2011/0024234 A1
(43) Pub. Date: Feb. 3, 2011

(54) Ladder Chair

(76) Inventor: Chen-Hsiung Lin, Lutsao Hsiang (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/512,234

(22) Filed: Jul. 30, 2009

(51) Int. Cl. E06C 1/383; E06C 1/28

(52) U.S. Cl. 182/161

(57) ABSTRACT

A ladder chair comprises a retaining unit disposed in a first step plate, and the retaining unit includes a knob, a spring, and a fastening piece; wherein the fastening piece is inserted in a notch and a recess of the first step plate, and one end of the fastening piece is connected with the knob, and the other end thereof engages with the first rear pivot of the first step plate by using a U-shaped hook; the knob is inserted in a cutout and extends out of the first step plate. Therefore, no matter the ladder chair is in expanding or retracting state, the ladder chair is locked securely as the knob is not pressed to obtain safety.

### BACKGROUND OF THE INVENTION

1. Field of the Invention

The present invention relates to a ladder chair that includes a retaining unit having a knob, a spring, and a fastening piece to obtain safe locking purpose.

2. Description of the Prior

Conventional ladder chair does not include a retaining unit, accordingly it is used insecurely to injure user. Furthermore, it can not be operated easily.

U.S. Pat. No. 6,390,237 B1 discloses a ladder step stool with latch including a knob to be pulled outward, wherein by using a first end of the latch to hook a cross member, the ladder step stool is in a lock state. As pushing the latch inward, the ladder step stool is in a release state. However, the ladder step stool does not include a flexible member, such as a spring to recover elasticity to lock the ladder step stool securely and easily.

The present invention has arisen to mitigate and/or obviate the afore-described disadvantages.

### SUMMARY OF THE INVENTION

The primary object of the present invention is to provide a ladder chair that no matter the ladder chair is in expanding or retracting state, the ladder chair is locked securely as the knob is not pressed to obtain safety.

Another object of the present invention is to provide a ladder chair that is operated to expand or retract easily and to prevent from injuring children. Also, the retaining unit of the ladder chair is made easily to lower production cost.

A ladder chair according to a preferred embodiment of the present invention comprises:

a front rack including a first opening facing downward and being formed in an inverted-C shape;

a rear rack including a second opening facing upward and being formed in an inverted-C shape;

two holders to insert the front rack and axially couple a rear end of the rear rack;

a stepping unit including a first step plate, a second step plate, and a third step plate, all of which have a first front pivot, a second front pivot, and a third front pivot respectively, and have a first rear pivot, a second rear pivot, and third rear pivot individually, each of the first, second, and third step plates pivotally connecting with the front rack by using the first front pivot, the second front pivot, and the third front pivot respectively;

two supports mounted on two sides of the stepping unit and each including a sliding slot, the two sides of the support being pivotally connected to the rear rack, the second rear pivot of the second step plate, and the third rear pivot of the third step plate;

two slidable shafts fixed on the two sides of the stepping unit, one end of the slidable shaft being axially coupled to the rear rack, and the other end thereof being slidably secured in the sliding slot of the support by ways of a locking element; wherein

the first step plate includes a retaining unit disposed therein, and the retaining unit includes a knob, a spring, and a fastening piece;

the fastening piece is inserted in a notch and a recess of the first step plate, and one end of the fastening piece is connected with the knob, and the other end thereof engages with the first rear pivot of the first step plate by using a U-shaped hook;

the knob is inserted in a cutout and extends out of the first step plate.

### BRIEF DESCRIPTION OF THE DRAWINGS

FIG. 1 is a perspective view showing the assembly of a ladder chair in accordance with a preferred embodiment of the present invention;

FIG. 2 is a cross sectional view showing the assembly of the ladder chair in accordance with the preferred embodiment of the present invention;

FIG. 3 is a partial perspective view showing a retaining unit of the ladder chair in accordance with the preferred embodiment of the present invention;

FIG. 4 is an amplified perspective view showing the retaining unit of the ladder chair in accordance with the preferred embodiment of the present invention;

FIG. 5 is a perspective view showing the exploded components of the retaining unit of the ladder chair in accordance with the preferred embodiment of the present invention;

FIG. 6 is a cross sectional view showing the locking state of the retaining unit of the ladder chair in accordance with the preferred embodiment of the present invention;

FIG. 7 is a cross sectional view showing the releasing state of the retaining unit of the ladder chair in accordance with the preferred embodiment of the present invention;

FIG. 8 is a cross sectional view showing the ladder chair being retracted.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

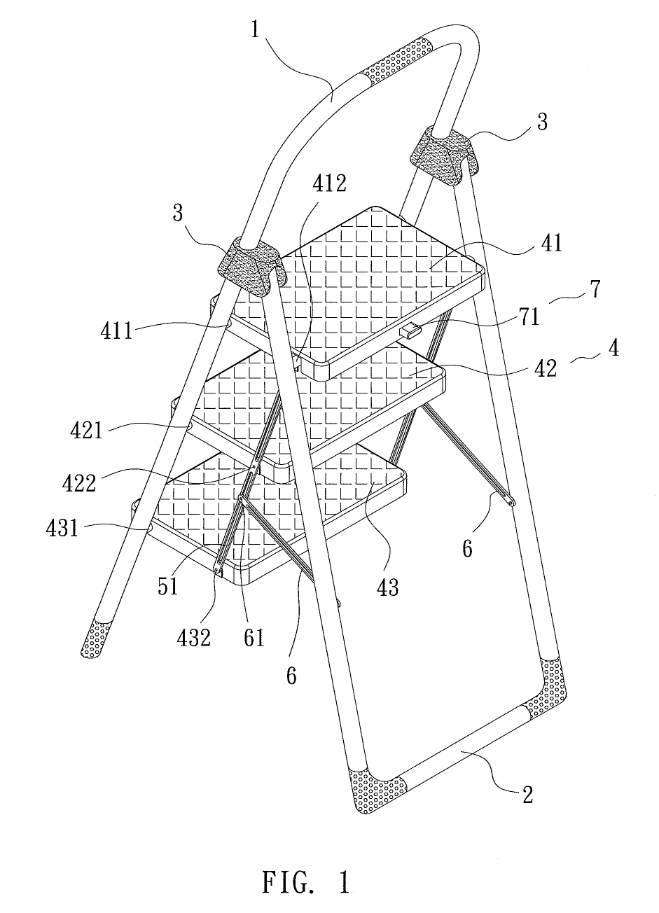

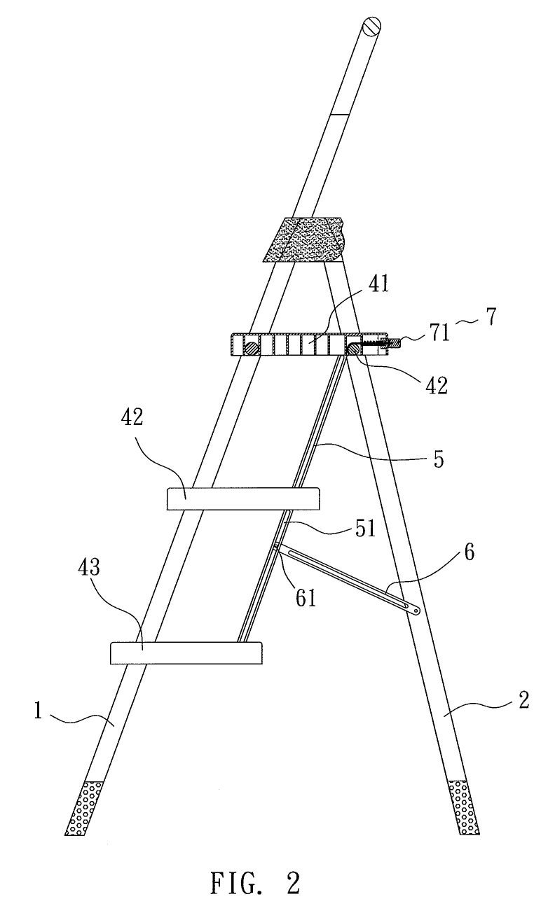

Referring to FIGS. 1-5, a ladder chair comprises:

a front rack 1 including a first opening facing downward and being formed in an inverted-C shape;

a rear rack 2 including a second opening facing upward and being formed in an inverted-C shape;

two holders 3 to insert the front rack 1 and axially couple a rear end of the rear rack 2;

a stepping unit 4 including a first step plate 41, a second step plate 42, and a third step plate 43, all of which have a first front pivot 411, a second front pivot 421, and a third front pivot 431 respectively, and have a first rear pivot 412, a second rear pivot 422, and third rear pivot 432 individually, each of the first, second, and third step plates 41, 42, 43 pivotally connecting with the front rack 1 by using the first front pivot 411, the second front pivot 421, and the third front pivot 431 respectively;

two supports 5 mounted on two sides of the stepping unit 4 and each including a sliding slot 51, the two sides of the support 5 being pivotally connected to the rear rack 2, the second rear pivot 422 of the second step plate 42, and the third rear pivot 432 of the third step plate 43;

two slidable shafts 6 fixed on the two sides of the stepping unit 4, one end of the slidable shaft 6 being axially coupled to the rear rack 2, and the other end thereof being slidably secured in the sliding slot 51 of the support 5 by ways of a locking element 61; wherein

the first step plate 41 includes a retaining unit 7 disposed on an interior thereof and having a knob 71 extending out of the first step plate 41;

the retaining unit 7 includes a spring 72 inserted into the knob 71;

the retaining unit 7 includes a fastening piece 73 connecting with the knob 71 by using a screw 74;

the knob 71 allows to recover its resilience after compression by ways of the spring 72.

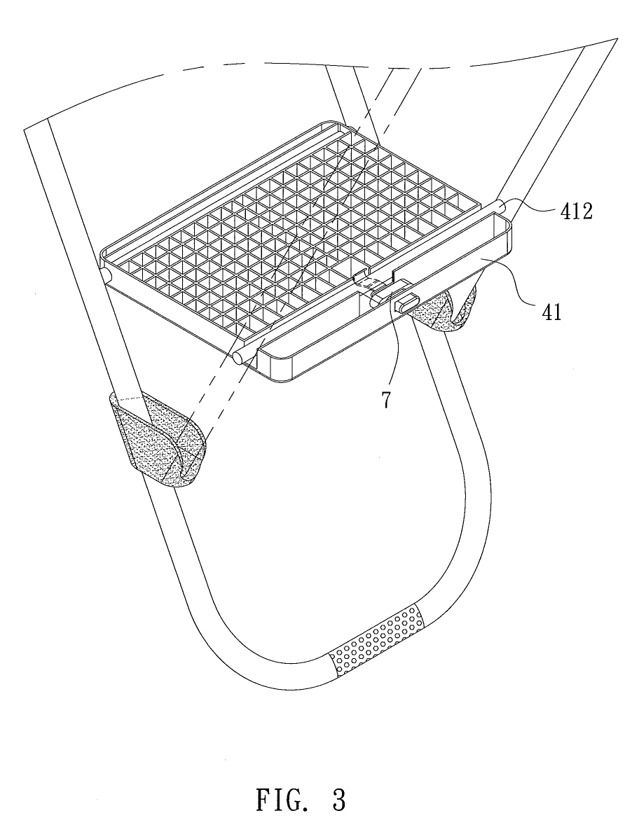

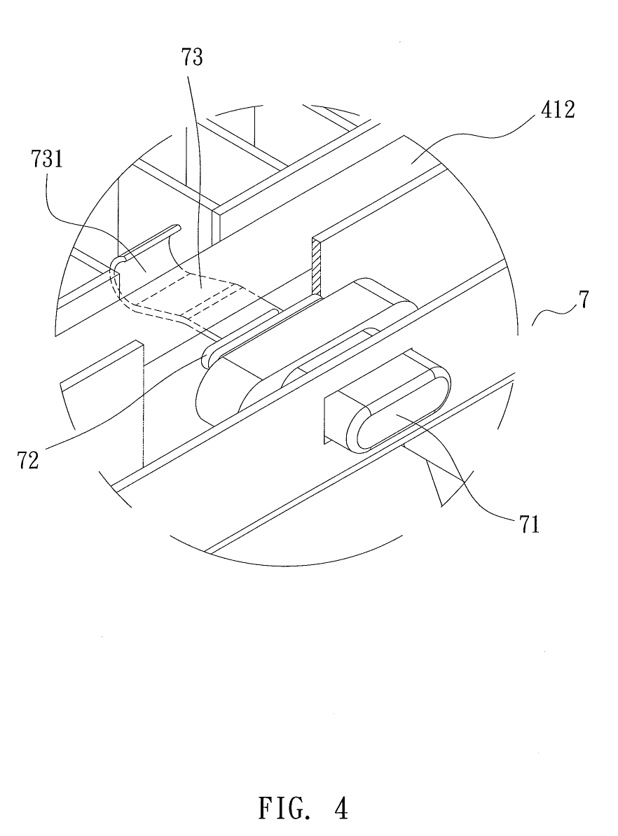

With reference to FIGS. 3 and 4, the first step plate 41 includes the retaining unit 7 disposed therein and having the knob 71, the spring 72, and the fastening piece 73, one end of which connects with the knob 71, and the other end of which engages with the first rear pivot 412 of the first step plate 41 by using a U-shaped hook 731, and the spring 72 is inserted in the knob 71.

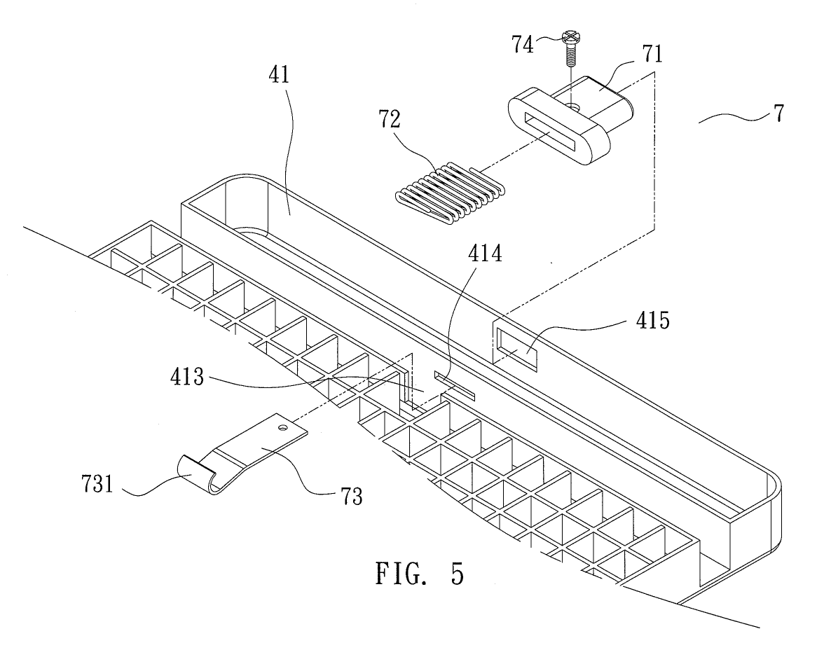

As illustrated to FIG. 5, the first step plate 41 includes the retaining unit 7 disposed therein and having the knob 71, the spring 72, and the fastening piece 73, the fastening piece 73 is inserted in a notch 413 and a recess 414 of the first step plate 41, one end of the fastening piece 73 couples with the knob 71, and the other end thereof engages with the first rear pivot 412 of the first step plate 41 by using the U-shaped hook 731 (as shown in FIGS. 3 and 4), and the knob 71 is inserted in a cutout 415 and extends out of the first step plate 41.

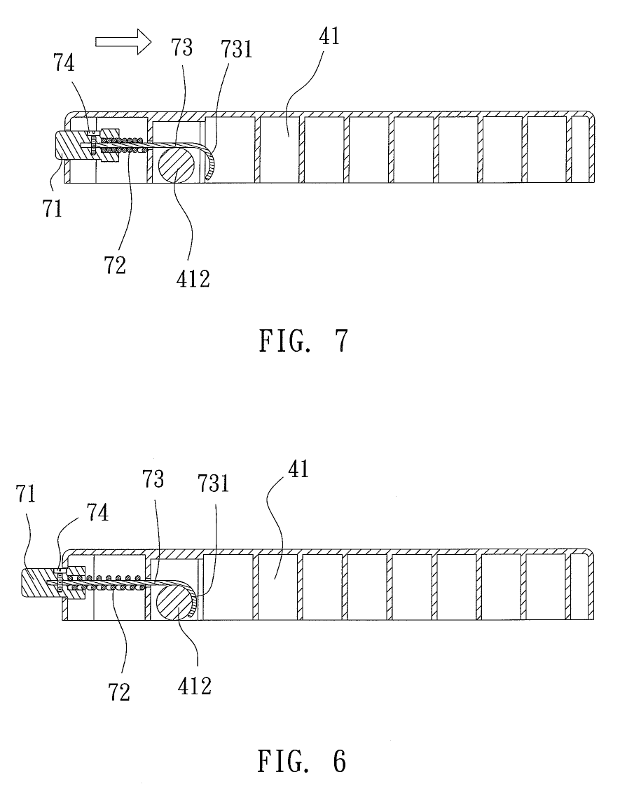

Referring to FIG. 6 which shows the retaining unit is in a locking state, wherein as the knob 71 of the retaining unit 7 is not pressed, the spring 72 (in a compressing type) is partially forced to be in a partially releasing status, and one end of the fastening piece 73 is connected to the knob 71 by using the screw 74, the other end of the retaining piece 73 engages with the first rear pivot 412 of the first step plate 41 by using the U-shaped hook 731 so that the first rear pivot 412 resiliently compresses the U-shaped hook 731 to obtain the locking state of the retaining unit.

Referring to FIG. 7 which shows the retaining unit is in a releasing state, wherein as the knob 71 of the retaining unit 7 is pressed inward, the spring 72 (in a compressing type) is forced completely, and the U-shaped hook 731 on the one end of the fastening piece 73 disengages from the first rear pivot 412 of the first step plate 41 to release the first rear pivot 412, thereby enabling to retract the ladder chair. After pressing the knob 71, the spring 72 recovers it elasticity to release the knob 71 to recover state as shown in FIG. 6, locking the first rear pivot 412 again.

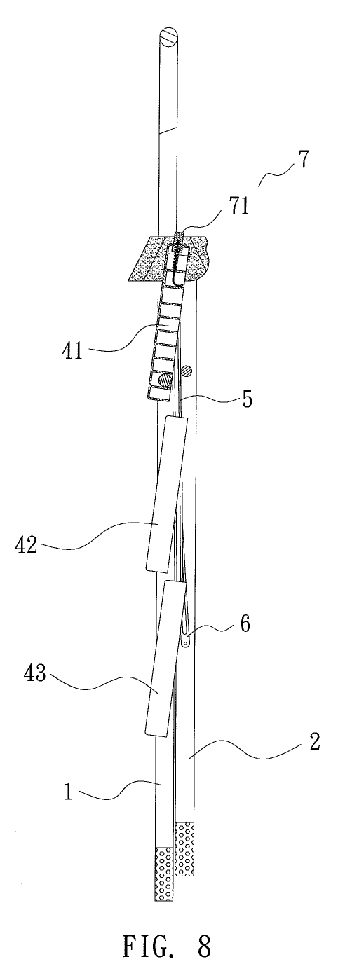

As illustrated in FIG. 8, as in a retracting status, the knob 71 is pressed continuously as shown in FIG. 7, so as to retract the ladder chair until it is in a smallest size, wherein the front rack 1 almost folds to the rear rack 2, and the first, the second, and the third step plates 41, 42, 43, the supports 5 and the slidable shaft 6 almost contact with each other to be stored. The knob 71 of the retaining unit 7 faces upward to be released easily to expand the ladder chair.

Therefore, no matter the ladder chair is in expanding or retracting state, the ladder chair is locked securely as the knob is not pressed to obtain safety.

In addition, the ladder chair is operated to expand or retract easily and to prevent from injuring children. Also, the retaining unit of the ladder chair is made easily to lower production cost.

While we have shown and described various embodiments in accordance with the present invention, it is clear to those skilled in the art that further embodiments may be made without departing from the scope of the present invention.

What is claimed is:

1. A ladder chair comprising:
a front rack including a first opening facing downward and being formed in an inverted-C shape;
a rear rack including a second opening facing upward and being formed in an inverted-C shape;
two holders to insert the front rack and axially couple a rear end of the rear rack;
a stepping unit including a first step plate, a second step plate, and a third step plate, all of which have a first front pivot, a second front pivot, and a third front pivot respectively, and have a first rear pivot, a second rear pivot, and third rear pivot individually, each of the first, second, and third step plates pivotally connecting with the front rack by using the first front pivot, the second front pivot, and the third front pivot respectively;
two supports mounted on two sides of the stepping unit and each including a sliding slot, the two sides of the support being pivotally connected to the rear rack, the second rear pivot of the second step plate, and the third rear pivot of the third step plate;
two slidable shafts fixed on the two sides of the stepping unit, one end of the slidable shaft being axially coupled to the rear rack, and the other end thereof being slidably secured in the sliding slot of the support by ways of a locking element; wherein
the first step plate includes a retaining unit disposed therein, and the retaining unit includes a knob, a spring, and a fastening piece;
the fastening piece is inserted in a notch and a recess of the first step plate, and one end of the fastening piece is connected with the knob, and the other end thereof engages with the first rear pivot of the first step plate by using a U-shaped hook;
the knob is inserted in a cutout and extends out of the first step plate.

2. The ladder chair as claimed in claim 1, wherein the spring of the retaining unit is inserted in the knob.

3. The ladder chair as claimed in claim 1, wherein the fastening piece of the retaining unit connecting with the knob by using a screw.

4. The ladder chair as claimed in claim 1, wherein the knob allows to recover its resilience after compression by ways of the spring.
